(19) United States
(12) Patent Application Publication
(10) Pub. No.: US 2004/0242419 A1
(43) Pub. Date: Dec. 2, 2004

(54) Systemic inducer composition for plants

(76) Inventor: A. Harry J. Rajamannan, Minneapolis, MN (US)

Correspondence Address: Herman H Bains, 6101 Tracy Avenue, Minneapolis, MN, 55436, US

(21) Appl. No.: 10/448,830

(22) Filed: May 30, 2003

(51) Int. Cl. A01N 63/00

(52) U.S. Cl. 504/118

(57) ABSTRACT

A systemic inducer comprising a nutrient combined with microorganismic substance extracted from microorganisms or insects. The nutrient or fertilizer includes an acid and/or the salt of phosphorus, potassium, calcium, sodium, magnesium, manganese, zinc, copper and iron. The microorganismic substance may be extracted from fungus, bacteria, virus or insects. The systemic inducer may be applied to stems, leaves, flowers or fruits of plants. Alternatively, the systemic inducer may be applied to soil to elicit a response via the roots of the plants. Finally, the systemic inducer may be injected into the stem or pseudo stem of the plants.

### FIELD OF INVENTION

This invention relates to compounds that can induce resistance to plants to ward off fungal, bacterial, viral and insect infestations.

### BACKGROUND OF THE INVENTION

Fertilizer are added to soil or sprayed on leaves to supply nutrients to grow crops. Phosphorus needed by plant is applied today in many forms. They are either phosphate salts derived from phosphoric acid or phosphite salts derived from phosphorous acid or the acids themselves.

Phosphate fertilizers have been on the market for several decades and phosphite fertilizers have been on the market in Australia and Europe since 1990. Phosphites to be used as fungicides was also patented as early as 1978 by U.S. Pat. No. 4,075,324.

Merck Index (M. Windhols, Ed 1983), 10^{th} edition monograph No. 1678) describes calcium phosphite as a fertilizer. Many scientific papers have been published since then on the use of phosphite fertilizers and phosphate fertilizers and these products are in public domain (Lovatt, Carol J. 1991, 1992).

Phosphorous acids have been used to fertilize soils and plants in Australia from 1980's. So phosphorous acids in themselves and salts of these acids called phosphites or phosphonates (Whiley et al; 1992) have been in use since 1990's and their use as fertilizers are in public domain.

Fungicides, bactericides and insecticides have been applied since the 1950's to control fungi, bacteria, insects and nematodes that attack the plants. These chemical pesticides are not only contaminating the environment, pose a danger to workers, leave traces of pesticides in the produce consumed, but are also becoming quite useless as these pathogens are fast developing resistance to these chemical agents.

Besides phosphates and phosphites elements, fertilizers containing potassium, calcium, magnesium, manganese, zinc, copper, iron and sodium have been used as fertilizers for several decades in many forms of salts and these fertilizers are also in public domain.

U.S. Pat. No. 6,372,238 discloses a process for implanting dry implant sticks into banana and plantain plants for providing nutrients and improving resistance to plant pathogens. The nutrient was slowly released over time and the implant provided reduction of infection by certain pathogens. However, the implant did not obtain the result of the composition of the present invention.

### SUMMARY OF THE INVENTION

An object of this invention is to provide a systemic inducer for plants including a nutrient material and live bacterial, fungus and viruses or a bacterial, fungal or viral extracts for inducing systemic resistance in plants to diseases such as downy mildew (plesmopara viticola), phytopthera, pythium, black and yellow sigatoka and resistance to insects.

In the embodiment disclosed, the nutrients or fertilizers are phosphoric acids, phosphorous acids, phosphates, phosphites, salts of calcium, magnesium, potassium, managanese, zinc, copper, iron and sodium. Microorganismic substances alive or in an extracted or hydrolyzed form is combined with the fertilizer material and applied to the plants to provide the systemic resistance to plant diseases.

The systemic inducer may be applied to the stem, leaves, flowers or fruits of plants. Alternatively, the systemic inducer may be applied to soil to elicit induction into the plants via the roots of plants. Finally, the systemic inducer may be injected into the stem or pseudo stem of the plant.

### DESCRIPTION OF THE PREFERRED EMBODIMENT

Plants have the ability to ward off infections by fungal, bacteria, virus and insects to a certain degree. Some varieties have natural resistance built in to ward off severe infections and some varieties do not have this ability.

The plants' inherent ability to develop resistance is called “systemic acquired resistance”. Any material that is applied to plants for plants to develop resistance is called “inducers”. So applying certain inducers can elicit certain plants to develop systemic resistance. This is a new field of investigation and development.

The closest parallel process is akin to a human developing resistance to a particular disease after being vaccinated. Simple salts such as phosphites, phosphates, oxalates and salicylates are known to provide a small degree of immunity to plants.

We have discovered that certain natural compounds like bacterial, fungal and viral extracts or the organisms themselves when combined with phosphoric acids, phosphorous acids or phosphite fertilizers or phosphate fertilizers can induce 100% systemic resistance in plants such that the need for applying pesticides to these plants to manage diseases such as, downy mildew (plasmopara viticola) phytopthera, pythium, black and yellow sigatoka is obviated.

In other words, we have developed products comprising organisms or extracts of these microorganisms combined with phosphoric acids, phosphorous acids, phosphates, phosphites, salts of calcium, magnesium, potassium, manganese, zinc, copper, iron and sodium which induce plants to develop enough resistance naturally to ward off fungal, bacterial, viral and insect infections such that no pesticides need to be applied.

The present invention provides a systemic resistance inducer that is obtained by combining a phosphorous acid and salts thereof, phosphoric acid and salts thereof and the salts of calcium, magnesium, potassium, zinc, manganese, copper, iron and sodium with extracts of microorganisms. The systemic inducer is applied to plants as a foliar application, or applied to the soil on which the plants are planted or injected into the stem or pseudo stem of these plants. These extracts do not by themselves cause any significant induction or invade the plant as they are not pathogenic, so the 100% effective induction is taking place only when these extracts are used in combination with the fertilizers listed above. Growth enhancers or regulators such as betaine, benzothio diazole, jasmonic acid, cytokinin, auxin and gibberellins, beta amino butyric acid may be combined to relieve the stress caused by the induction program. Salicylates, oxalates, napthaletes have also showed some induction of resistance, but when combined with the nutrients they add to the induction process effectiveness and with increases in productivity.

### EXAMPLE 1

Microorganisms were grown in a medium and allowed to die by attenuating it with formaldehyde or exposing to microwaves or hydrolyzed with acids and the extracts obtained from these organisms were tested for induction of resistance on various plants such as strawberry, apple, citrus, tomato, grapes and banana. These plants thus treated were then challenged by exposing the plants to pathogens such as mildew, phytopthera, black sigatoka and thrips and mites. The plants suffered severe infestation. But when these same extracts were combined with a phosphate or phosphite or calcium nitrate or magnesium sulfate and applied to a new set of plants in the same manner of the application of extracts alone, all plants resisted the infestation of fungal and insects.

### EXAMPLE 2

The specific microorganisms such as pseudomonads tricboderma species, bacillus subtilis rhodotorulum species, xanthomonas species, plant growth promoting Rhyzobacteria such as IN 937b and SE 34 were specifically cultured, hydrolyzed and used as is or in combination with a calcium phosphite, potassium phosphate, calcium citrate on a set of plants. Such plants include lettuce, strawberry, tomato, grapes, banana, blueberry, apples, corn and potatoes.

Three applications were made at two week intervals prior to the window and during period of heavy natural infestations. In banana injections were continued for 6 months with monthly injections with no fungicides applied.

When the infestation time arrived, the insect traps that were placed in the blocks where the combined product was used to treat showed zero infestation by insects, such as thrips, mites, Japanese beetle, leaf hopper and blueberry maggot fly while the non-combined product used showed heavy infestation.

There was no scab in the apple, potatoes had no signs of infection by rhyzoctonia, phytopthera on tomato, and citrus. There was no leaf fungal infection on the leaves on potato, strawberry, citrus, tomato and no sigatoka infection occurred in bananas. There were no insects to be found in the traps or on the leaves.

When these same bacteria were applied by themselves to plants that were exposed to the various pathogens little if any resistance was found to be induced.

### EXAMPLE 3

These microorganisms used in Experiment 2 were ground up in a Dyno-Mill type KDL manufactured by Willy A. Bachofenag Maschinen Fabrik, Basel, Switzerland to 5 to 1 mu size and these extracts containing proteins, peptides and ribonucleotides and deoxy ribonucleotides were then combined with same fertilizers as used in Example 2 and then sprayed on the same list of plants as in Example 2, but in the case of banana the product was injected monthly into the pseudo stem of the banana for 6 months.

The results in bananas took 2-3 months to elicit the resistance against black sigatoka but the insects also did not attack the fruit of plants treated with the combination.

On tomatoes and citrus the effect was within 1 to 4 weeks. New root flush was measured and new leaves were growing and the dieback was stopped.

All apple trees showed zero infection by bacteria (fireblight in apples) disease and fungal disease on leaves.

### EXAMPLE 4

Extracts from garlic, tea tree oil (maleluca), vanilla extract, marigold extracts were combined with potassium phosphite and calcium phosphite and used in field trials to evaluate insect resistance by plants. Tomato, banana, apple, grapes, blueberry and the combinations out performed the extracts by themselves or the fertilizer by themselves.

What is claimed is:

1. A liquid systemic inducer composition for plants comprising a plant nutrient selected from the group consisting of phosphoric acid, phosphorus acid or salts thereof, or the salts of an element selected from the group consisting of phosphorus, potassium, calcium, sodium, magnesium, manganese, zinc, copper and iron, and a microorganismic substance selected from the group consisting of an extract from microorganisms, an extract from fungi, live microorganisms, and live fungi for application to plants for inducing resistance to infestation by insects, fungus, bacteria and viruses.

2. A method of providing a systemic inducer to plants comprising, combining a nutrient selected from the group consisting of phosphoric acid and phosphorous acid or the salts thereof, or the salts of an element selected from the group consisting of phosphorus, potassium, calcium, sodium, magnesium, manganese, zinc, copper, and iron, with a microorganismic substance selected from the group consisting of an extract from microorganisms, an extract from insects, an extract from viruses, an extract from fungi, live bacteria, live viruses, and live fungi, and applying the systemic inducer to plants for inducing resistance to the plants to infestation by insects, fungi, bacteria and viruses.

3. The systemic inducer as defined in claim 1 wherein the phosphorus acid is phosphorous acid, and the salts thereof.

4. The systemic inducer as defined in claim 1 wherein the microorganisms comprise Bacillus, sp.

5. The systemic inducer as defined in claim 1 wherein the microorganism is hydrolyzed to extract the proteins and peptides therefrom.

6. The systemic inducer as defined in claim 1 wherein the microorganisms are hydrolyzed and then ground up sufficiently to extract nucleotides therefrom including deoxyribonucleotides and ribonucleotides.

7. The systemic inducer as defined in claim 1 including a growth enhancer selected from the group consisting of betaine, cytokinin, iso-nicotinic acid, benzothiadizole, beta-amino-butyric acid, gibberellins, auxin and jasmonic acid.

8. The systemic inducer as defined in claim 1 and a substance selected from the group of extracts of marigold, tea tree oil, garlic extract, vanilla extract and neem oil to additionally induce strong resistance to insects.

9. The method as defined in claim 2 wherein the systemic inducer is injected into the flower bud of a banana plant or plantain plant (green banana) just before the bud opens to induce resistance to the banana fruit bunch from insects, birds and bats.

10. The method as defined in claim 2 wherein the systemic inducer is sprayed on the young fruit of a banana plant or plantain plant before the flower of the plant is bagged for protection from insects.

11. The method as defined in claim 2 wherein the systemic inducer is applied to the stems, leaves, flowers or fruits of the plants.

12. The method as defined in claim 2 wherein the systemic inducer is applied to the soil where plants are growing to elicit a response in the plants via the roots of the plants.

13. The method as defined in claim 2 wherein the systemic inducer is injected into the stems or pseudo stems of the plants.

14. The systemic inducer composition as defined in claim 2 wherein the nutrient is phosphoric acid or the salts thereof.

15. The systemic inducer composition as defined in claim 2 wherein the nutrient is phosphorous acid or the salts thereof.

16. The systemic inducer composition as defined in claim 2 wherein the nutrient is a salt selected from the group consisting of phosphorus, potassium, calcium, sodium, magnesium, manganese, zinc, copper and iron.

17. A systemic inducer composition as defined in claim 1 including salicylic acid or its salts, oxalic acid or its salts.

18. A systemic inducer composition for plants comprising plant nutrients selected from the group consisting of acids or salts or combinations of acids and salts derived from one or more of phosphorous, calcium, potassium, magnesium, manganese, sodium, sulfur, copper, iron, cobalt combined with microorganisms in forms consisting of live, extracted or hydrolyzed for the purpose of inducing resistance to infestation by insects, fungus, bacteria and viruses.

19. The systemic inducer as defined in claim 1 wherein the phosphorous acid is polyphosphorous acid and the salts thereof.

20. The systemic inducer as defined in claim 1 wherein the phosphorous acid is hypophosphorous acid and the salts thereof.

21. The systemic inducer as defined in claim 1 wherein said phosphorus acid is polyphosphorous acid and the salts thereof.

22. The systemic inducer as defined in claim 1 wherein the phosphorus acid is polypophorphorous acid and the salts thereof.

23. The systemic inducer as defined in claim 1 wherein the microorganisms comprise Xanthomonas sp.

24. The systemic inducer as defined in claim 1 wherein the microorganisms comprise Rhodotorulum sp.

25. The systemic inducer as defined in claim 1 wherein the microorganisms comprise Trichoderma sp.

26. The systemic inducer as defined in claim 1 where the microorganisms comprise Pseudomonas sp.

27. The systemic inducer as defined in claim 1 wherein the microorganisms comprise Rhyzobacterium is including IN 937b and SE 34 species.
